(19) United States
(12) Patent Application Publication
(10) Pub. No.: US 2014/0046694 A1
(43) Pub. Date: Feb. 13, 2014

(54) SYSTEMS AND METHODS FOR SYNOPTIC ELEMENT STRUCTURED REPORTING

(71) Applicant: Keith Stevenson White, Salt Lake City, UT (US)

(72) Inventor: Keith Stevenson White, Salt Lake City, UT (US)

(21) Appl. No.: 13/961,135

(22) Filed: Aug. 7, 2013

Related U.S. Application Data
(60) Provisional application No. 61/681,057, filed on Aug. 8, 2012.

(51) Int. Cl. G06Q 50/24; G06Q 10/00

(52) U.S. Cl. CPC G06Q 50/24; G06Q 10/00
USPC 705/3

(57) ABSTRACT

A method for synoptic element structured reporting on a computing device is described. The method includes identifying a clinical context. The method also includes identifying a key question based on the identified clinical context. The method further includes obtaining an answer to the key question. The method additionally includes codifying the answer to produce a codified answer. The method also includes storing the codified answer in a database.

### RELATED APPLICATIONS

This application is related to and claims priority from U.S. Provisional Patent Application Ser. No. 61/681,057, filed Aug. 8, 2012 for “Method for Synoptic Element Structured Reporting on a Computing Device,” which is incorporated herein by reference.

### TECHNICAL FIELD

The present disclosure relates generally to computers and computer-related technology. More specifically, the present disclosure relates to systems and methods for synoptic element structured reporting.

### BACKGROUND

Computer and communication technologies continue to advance at a rapid pace. Indeed, computer and communication technologies are involved in many aspects of a user's day. Computers commonly used include everything from hand-held computing devices to large multi-processor computer systems.

Computer technology is becoming increasingly important in the medical services environment. For example, computers may assist doctors in treating patients. Also, computer systems may be used in the medical environment to assist doctors in sharing patient information with each other. For example, a specialist may examine a patient and send a report back to a referring doctor or store the report in a hospital database.

Medical providers often find that these reports can be tedious to sort through and may not provide clear answers to important questions about a patient's condition. This may cause several problems, including an inability to properly treat a patient and putting a patient through unnecessary procedures. The complexity of information included in a report in many cases is, for practical reasons, either rapidly scanned or even ignored. Further, text-based reports also provide information in a format that can be difficult or impossible to accurately encode into database structures, thereby limiting the capabilities of computing systems to process data and perform advanced computing tasks such as computer assisted medical decision making. Therefore, improvements in reporting in the medical services environment may be beneficial.

### BRIEF DESCRIPTION OF THE DRAWINGS

FIG. 1 is a block diagram illustrating one configuration of a computing device for synoptic element structured reporting;

FIG. 2 is a flow diagram illustrating a method for synoptic element structured reporting;

FIG. 3 is a flow diagram illustrating a method for selecting a clinical context;

FIG. 4 is a block diagram illustrating an example of a computing network in which a computing device for synoptic element structured reporting may be implemented;

FIG. 5 is a flow diagram illustrating a more specific method for synoptic element structured reporting;

FIG. 6 is a flow diagram illustrating a method for identifying key questions;

FIG. 7 is a flow diagram illustrating a method of defining and codifying a clinical context;

FIG. 8 is a flow diagram illustrating a method for modifying a clinical context; and

FIG. 9 illustrates various components of a computing device that may be utilized for synoptic element structured reporting.

### DETAILED DESCRIPTION

A method for synoptic element structured reporting on a computing device is described. The method includes identifying a clinical context. The method also includes identifying a key question based on the identified clinical context. The method also includes obtaining an answer to the key question. The method also includes codifying the answer to produce a codified answer. The method also includes storing the codified answer in a database.

The clinical context, the key question and the answer may each be codified. The clinical context may be determined based on a patient attribute. The clinical context may further be divided into clinical sub-contexts. The attribute may be selected from the group consisting of age, gender, known diseases, reason for exam and patient location. Each answer may be selected from the group consisting of a measurement, a unit, a quantity, a range, a selection, a value, a rank, a scale and a text field.

The method may also include selecting an exam protocol based on the clinical context. The method may also include combining a plurality of codified answers to create a case set. The case set may include statistical data regarding a clinical context. The method may also include modifying the key question based on the statistical data.

The method may also include limiting a number of key questions to a predetermined number. The method may also include identifying an additional key question based on the answer. The method may be used for diagnostic imaging studies. The database may include electronic medical records.

An apparatus for synoptic element structured reporting is also described. The apparatus includes a processor and memory in electronic communication with the processor. The apparatus also includes instruction stored in the memory. The instructions are executable to identify a clinical context. The instructions are also executable to identify a key question based on the identified clinical context. The instructions are also executable to obtain an answer to the key question. The instructions are also executable to codify the answer to produce a codified answer. The instructions are also executable to store the codified answer in a database.

A non-transitory computer-readable medium for synoptic element structured reporting is also described. The computer-readable medium includes executable instructions for identifying a clinical context. The computer-readable medium also includes executable instructions for identifying a key question based on the identified clinical context. The computer-readable medium also includes executable instructions for obtaining an answer to the key question. The computer-readable medium also includes executable instructions for codifying the answer to produce a codified answer. The computer-readable medium also includes executable instructions for storing the codified answer in a database.

The systems and methods disclosed herein may allow for synoptic element structured reporting. Synoptic element structured reporting may provide a logical and workable report structure of key elements (e.g., synoptic elements) derived from an understanding of how information flows through a medical environment. For example, synoptic element structured reporting may allow a medical provider to receive a report from another medical expert that includes specific and discrete answers to key questions that relate to synoptic elements of a patient's condition. Further, synoptic element structured reporting as described herein may be beneficial by providing medical providers information corresponding to codified data regarding patients who share similar clinical contexts. Other benefits from the present systems and methods may include improved productivity, improved standardization of report content and/or codification of report data.

Various configurations are now described with reference to the figures, where like reference numbers may indicate functionally similar elements. The systems and methods as generally described and illustrated in the figures herein could be arranged and designed in a wide variety of different configurations. Thus, the following more detailed description of several configurations, as represented in the figures, is not intended to limit scope, as claimed, but is merely representative of the systems and methods.

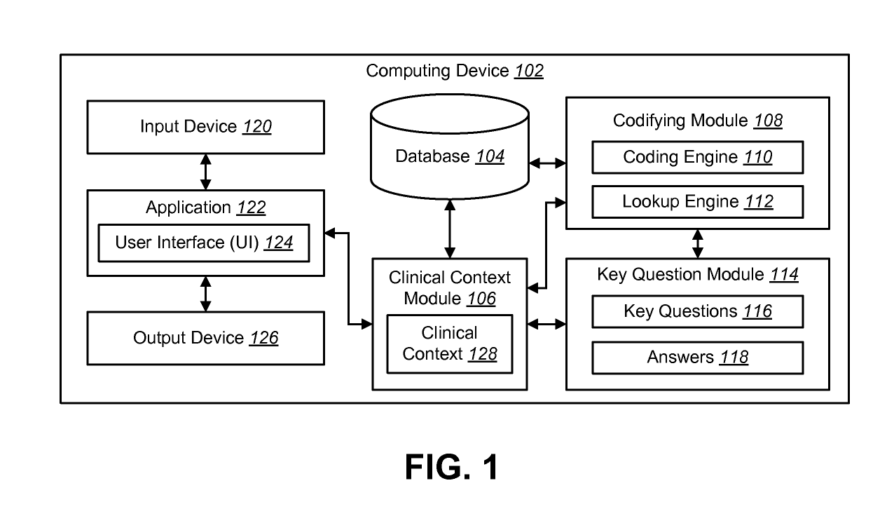

FIG. 1 is a block diagram illustrating one configuration of a computing device 102 for synoptic element structured reporting. Examples of the computing device 102 may include one or more desktop computers, laptop computers, servers, supercomputers, smartphones, tablet devices, game consoles, e-readers and/or other devices that include memory and a processor. Although several elements are illustrated within the same computing device 102 in FIG. 1, one or more of the illustrated elements may be included in a separate device. For example, the computing device 102 may represent one or more computing devices and/or other devices, where each includes one or more of the components illustrated in FIG. 1.

The computing device 102 may include one or more input devices 120 and one or more output devices 126. Examples of different kinds of input devices 120 include a keyboard, mouse, microphone, remote control device, button, joystick, trackball, touchpad, lightpen, etc. Examples of different kinds of output devices 126 include a speaker, printer, etc.

The computing device 102 may include an application 122 having a User Interface (UI) 124. The application 122 may assist a user, such as a medical professional, to perform synoptic element structured reporting. The UI 124 may allow the user to navigate through the application 122. For example, the UI 124 may allow a medical professional to input data into the application 122 via one or more input devices 120.

The computing device may include a database 104. The database 104 may store data generated from other components located on the computing device 102. The data may relate to patient information or medical records. In some configurations, the database may include electronic medical records (EMR). The data stored in the database 104 may be codified. Further, having a data model that establishes up-front encoding (e.g., codification) in the database 104 may increase the ability to store and retrieve encoded data.

The computing device 102 may also include a clinical context module 106. The clinical context module 106 may include one or more clinical contexts 128. A clinical context 128 may be a set of attributes, characteristics, diagnoses and/or symptoms that characterize a patient's current condition. For example, a clinical context 128 may be identified by the sign or symptom presented by the patient or by the treatment/test prescribed by a user (e.g., doctor). In addition, a clinical context 128 may be associated with a set of exams or procedures that may be required to answer one or more identified key questions 116. For example, a clinical context 128 may be identified as an “acute knee injury,” “uncommon headache,” “broken rib,” etc. (e.g., a patient's condition). Further, a clinical context 128 may be identified as “X-ray to test for pneumonia,” “MRI brain scan,” “blood draw for Hepatitis,” etc. (e.g., an exam or procedures required to answer key questions 116). Additional examples of clinical contexts 128 will be provided below.

The majority of issues that medical providers (e.g., doctors, technologists, medical experts, etc.) face when treating patients are clear and identifiable repetitious patterns. For example, about 30 clinical contexts 128 may comprise about 80% of the cases treated by medical providers. By grouping these repeating patterns into groups (e.g., clinical contexts 128), the seemingly infinite complexity of patient attributes and symptoms may be narrowed to a select number of finite and manageable clinical contexts.

The clinical context module 106 may identify and select a clinical context 128. As used herein, a “module” may be implemented in hardware, software or a combination of both. For example, the clinical context module 106 may be implemented in hardware, software or a combination of hardware and software.

The computing device 102 may include a key question module 114. The key question module 114 may include key questions 116 and answers 118 (i.e., key answers). The answers 118 may correspond to the key questions 116, as will be discussed below. Key questions 116 and answers 118 may assist users in more effectively treating a patient. Answers 118 may take a variety of forms. For example, an answer 118 may be a measurement, such as the measured displacement of a fracture. The answer 118 may include a unit, a quantity, a range such as high, medium or low, a rank, a scale, a selection, such as from a drop down box, a binary answer, or a number, such as the number of nodes present. In some instances, the answer 118 may be an empty text field for a user to input text.

The computing device 102 may include a codifying module 108. The codifying module 108 may include a coding engine 110 and a lookup engine 112. The coding engine 110 may assign codes to clinical contexts 128, key questions 116 and/or answers 118. Thus, synoptic elements, such as key questions 116 and answers 118, may be codified in a structured format.

The lookup engine 112 may assist with searching for codified data. The lookup engine 112 may use a variety of words, numbers, codes, etc., to identify and look up data. For example, a medical provider may use the lookup engine 112 to provide codified data regarding previous patients sharing the same or a similar clinical context 128. As another example, the lookup engine 112 may filter the possibilities of clinical contexts 128 based on submitted attributes. In some configurations, the lookup engine 112 may look up coded data and/or may assist the coding engine 110 in identifying codes to be assigned to uncodified data.

The computing device 102 may help to overcome current challenges and shortfalls found in known approaches of medical reporting. One current challenge in the medical services environment today is a lack of feedback between users (e.g., doctors) treating patients with similar conditions or clinical contexts. This challenge is readily apparent when comparing medical reports of different patients sharing the same clinical context. Currently, when a medical expert creates a report, the report often includes key pieces of information pertaining to a patient's current and future health. But these reports can be difficult to sort through and the key pieces of information may not be discernible by other users, such as fellow medical personal.

As an example of this challenge, in the field of diagnostic imaging studies (e.g., radiology), when a patient receives an X-Ray, the diagnostic image is sent to a medical expert such as a radiologist to interpret. Traditionally, the results are reported in long paragraphs of prose with little or no standardized format. For instance, the radiologist may use voice dictation and transcription software to convert a verbal report into text. These paragraphs of text are stored for future review, but discrete codified data elements are not stored. In other words, these reports are not easily codified into database formats and access to important clinical data requires that a physician carefully read the text report. Further, imaging report data is not easily adapted to medical decision support processes that require data to be available in codified format.

In addressing this challenge, attempts to change reporting from prose text to structured data have largely failed. Organizations such as the Radiological Society of North America (RSNA) have recently developed standard report templates that establish recommended formats for standardized textual structure. Acceptance of these structured reports has been poor, and despite the interest in structured reporting, dictation of prose continues as nearly the sole mechanism for generating reports for most radiology exams. Further, these standardized reports merely organize the prose into smaller directed sections, but they do not codify the data in any type of manner that can be easily analyzed further without extensive processing.

Other previous attempts to require the use of templates have also failed. In some cases, the templates are customizable and not standardized, which negates the purpose of a standardized reporting template. Further, these templates have focused on format per se rather than on substance and subject matter. When codifiable fields are incorporated into a template, every piece of data in the report is codified together as a whole. Therefore, because of the tedious nature of laboriously filling in each template element, the drastic change from current practices and compromised productivity, these types of templates have proved problematic. Further, previous attempts at codification methods have not been logically structured, making accessing the stored elements difficult.

Another attempted solution has been to use natural language search recognition software after prose-based reports have been created. This involves having an electronic device search through paragraphs of text for key words and phrases. However, this attempt has likewise not yielded much success. Further, reports often lack the exact key words and phrases that the natural language software is searching for. Accordingly, potentially useful data included in each report may be ignored or lost.

In addition, because these reports include no formal structure, key pieces of information may be omitted. For example, a user, such as a referring doctor, who sends a patient to get a chest X-Ray to test for pneumonia may have trouble extracting whether or not the patient had pneumonia from reading the report. Thus, if the medical doctor cannot extract key pieces of information from reading a textual report, it is unlikely that natural language search recognition software will perform any better. Therefore, defining clinical contexts, establishing key questions for the context, and answering key questions 116 will increase the standardization of report content and ensure that feedback is provided.

As described previously, the computing device 102 may perform synoptic element structured reporting. For example, the computing device 102 may create a more efficient and streamlined process in medical reporting that provides useful and relevant feedback between users, such as medical doctors.

The computing device 102 may receive data via the input device 120. For example, a user, such as a medical specialist, may enter a patient's attributes via the input device 120. For instance, a patient seeking medical attention may arrive at a hospital or a clinic seeking medical attention. The patient may present attributes such as symptoms or conditions to the user (e.g., doctor). The user may input the attributes into the application 122. Attributes may include age, gender, signs or symptoms, examination type, site of service (e.g., inpatient, outpatient or emergency room), exam description, patient location, evaluation of acute problem, known problem, etc.

The application 122 may provide the attributes to the clinical context module 106. In some configurations, the clinical context module 106 may be part of the application 122. The clinical context module 106 may identify a clinical context 128 based on the received attributes. As described above, the clinical context 128 may be associated with a set of exams or procedures that may be required in order to answer the identified key questions 116. Further, the clinical context 128 may be a set of attributes, characteristics, diagnoses and/or symptoms that characterize a patient's current condition.

The clinical context module 106 may provide the clinical context 128 to the key question module 114. The clinical context module 106 may use the clinical context 128 to identify key questions 116. Corresponding answers 118 may be provided for each key question 116. For example, a key question 116 may ask if a test yields a positive or negative result. In this case, the corresponding answer 118 may provide a user with the binary choice of “yes” or “no.” In some configurations, the user may be required to select an answer; in other words, the user is required to answer the key question 116. In another configuration, the answer 118 may be set to “no” by default unless changed by a user.

The coding engine 110 in the codifying module 108 may assign codes to clinical contexts 128, key questions 116 and/or corresponding answers 118. For example, the clinical context 128 of “acute knee trauma” may be coded with the code 1234. Two key questions identified in connection with this clinical context 128 (e.g., knee trauma) may be coded with the codes 1234.1 and 1234.2, respectively. Codification of each clinical context 128, each key question 116 and each answer 118 may be performed in a variety of ways.

The coding engine 110 may also code answers 118. The code used to code an answer 118 may be similar to the code used to code a corresponding key question 116. For example, if a key question 116 is coded 1234.1q, the respective answer 118 may be coded as 1234.1a. Alternatively, the code used for codifying the answer 118 may be unrelated to the associated coded key question 116.

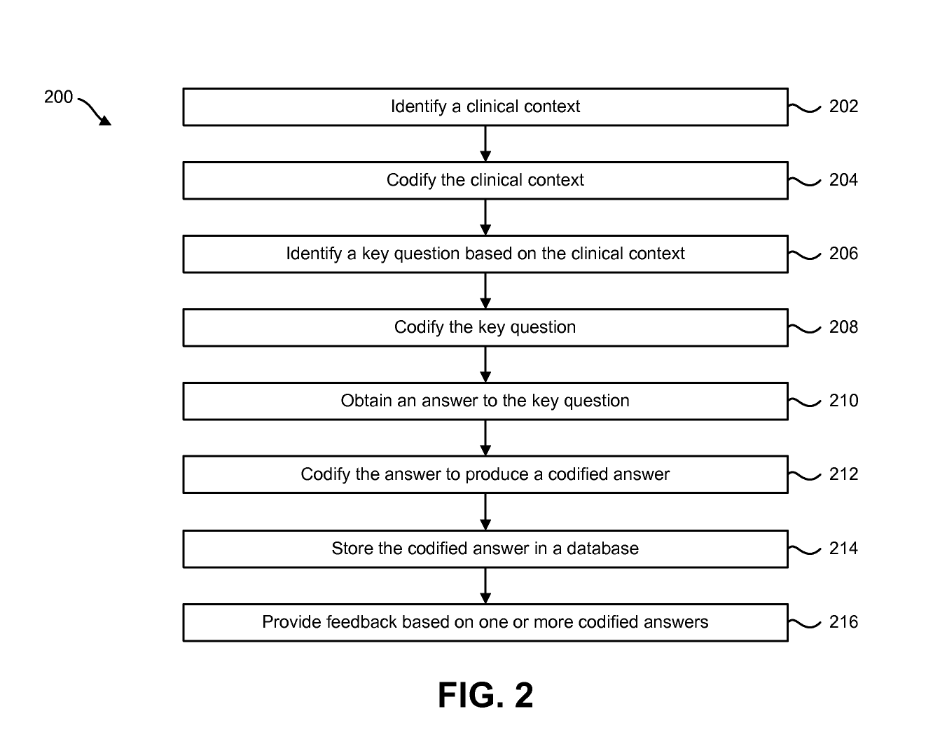

The lookup engine 112 may identify coded data that is associated with clinical contexts 128, key questions 116 and/or answers 118. The lookup engine 112 will be described in greater detail below in connection with FIG. 2.

In some configurations, the computing device 102 may be integrated into a medical system that includes imaging services, medical records, archival data and/or other information. In some instances, the computing device 102 may be integrated with other subsystems. One example of such a subsystem may be a Radiology Information System (RIS). The RIS may record information such as patient demographics, case history or treatment orders and use that information to identify a clinical context. Other systems that independently create records when patients undergo image capturing procedures may also be integrated with the computing device 102. For example, a Picture Archive Communication System (PACS) may store images captured by an imaging device along with patient information. These images may be useful in answering identified key questions 116. Some of these imaging devices may include a Computed Tomography (CT) scanner, Magnetic Resonance Imaging (MRI) scanner, X-Ray machine, Ultrasound (US) machine, Positron Emission Tomography (PET) scanner, Computed Radiography (CR) scanner, Mammogram (MG) equipment and Digital Radiography (DR) equipment, amongst others. In some configurations, the synoptic element structure reporting may conform to Health Level Seven International (HL7) standards.

In some configurations, synoptic element structure reporting may include identifying repeatable clinical contexts 128, identifying key questions 116 or synoptic elements for each clinical context 128, and codifying clinical contexts 128, key questions 116 and answers 118 so they can be identified within a database 104. In some configurations, synoptic element structure reporting may allow for automated or semi-automated processes for identifying a clinical context 128 and populating synoptic elements at the time of reporting, as will be discussed below.

In one configuration, a key question 116 and answer codification may include reference to other structured data that comes from other external computerized systems such that this data may be automatically stored as key answers 118. For example, a key question 116 on a renal ultrasound could be a renal length. This value could be available as part of a Dicom Structured Report and through accessing that report, the value for the key question 116 may be obtained without any user input.

Synoptic element structure reporting may provide a variety of benefits. For example, standardization of clinical contexts 128 may allow for data to be compared and transferred between health care systems. For instance, synoptic element structure reporting, as described herein, may be incorporated into computerized physician order-entry (CPOE) systems and/or into workflow management software such as a Picture Archive Communication System (PACS) or voice recognition reporting systems.

FIG. 2 is a flow diagram illustrating a method 200 for synoptic element structured reporting. The method 200 illustrated in FIG. 2 may be performed by the one or more computing devices 102 discussed in connection with FIG. 1. The computing device 102 may be located in a medical environment such as a hospital or a clinic.

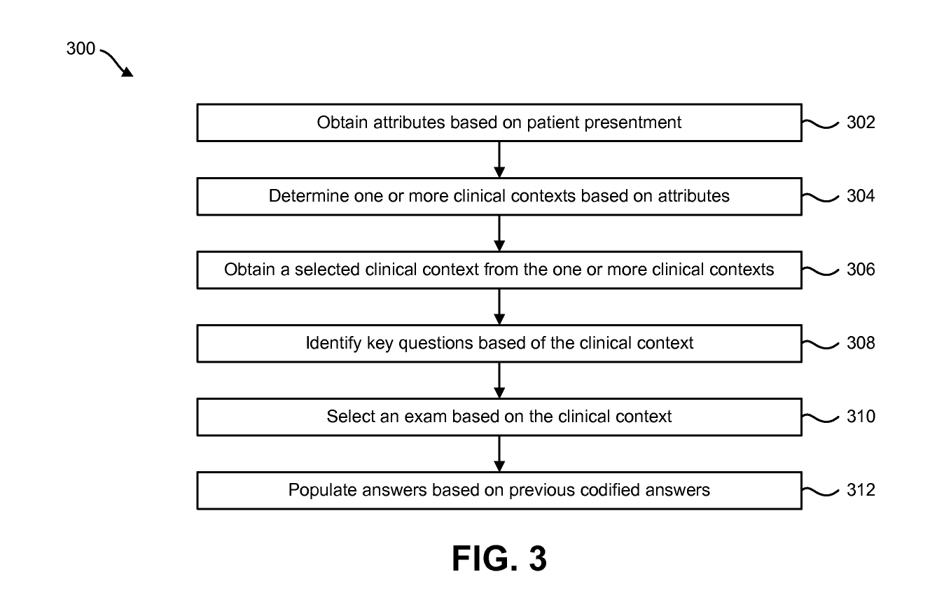

The computing device 102 may identify 202 a clinical context 128. For example, the clinical context module 106 may identify 202 a clinical context based on a patient's submitted attributes. Attributes may include age, gender, signs or symptoms, examination type, site of service (e.g., inpatient, outpatient or emergency room), exam description, patient location, evaluation of acute problem, known problem, etc. Identifying a clinical context 128 based on a patient's attributes is discussed in greater detail below in connection with FIG. 3. In some configurations, the computing device 102 may codify 204 the clinical context 128 (e.g., the identified clinical context 128).

The lookup engine 112 may determine from the clinical context 128 what the appropriate codification of the context should be. This coded value may be stored directly to the database 104 or retained in memory for use in downstream processing.

The computing device 102 may identify 206 a key question 116 (e.g., one or more key questions 116) based on the clinical context 128. The key questions 116 may be identified based on the clinical context 128 as stored in the clinical context module 106, in the database 104, or elsewhere in the computing device 102. The clinical context module 106 may provide the clinical context 128 to the key question module 114. In one configuration, the clinical context module 106 may access a database 104 to look up key questions 116 based on the clinical context 128. In another configuration, the clinical context module 106 may employ a codifying module 108 to identify key questions 116. In some configurations, the computing device 102 may codify 208 the key question 116 (e.g., the identified key question 116).

The lookup engine 112 in the codifying module 108 may also look up the clinical context 128 and identify one or more key questions 116. The lookup engine 112 may search the database 104 to identify corresponding key questions 116.

The number of identified key questions 116 may be limited to a predetermined number. For example, each clinical context 128 may be associated with five or fewer questions. Limiting the number of key questions 116 to a predetermined number allows the key questions 116 to be answered quickly and accurately. In other words, if the number of key questions 116 is limited, the computing device 102 may require that all questions are answered such that the user answering the questions is not overwhelmed or frustrated with a large number of questions. Thus, limiting the number of key questions 116 may prove beneficial for quick review and may ensure that each key question 116 receives an accurate answer 118.

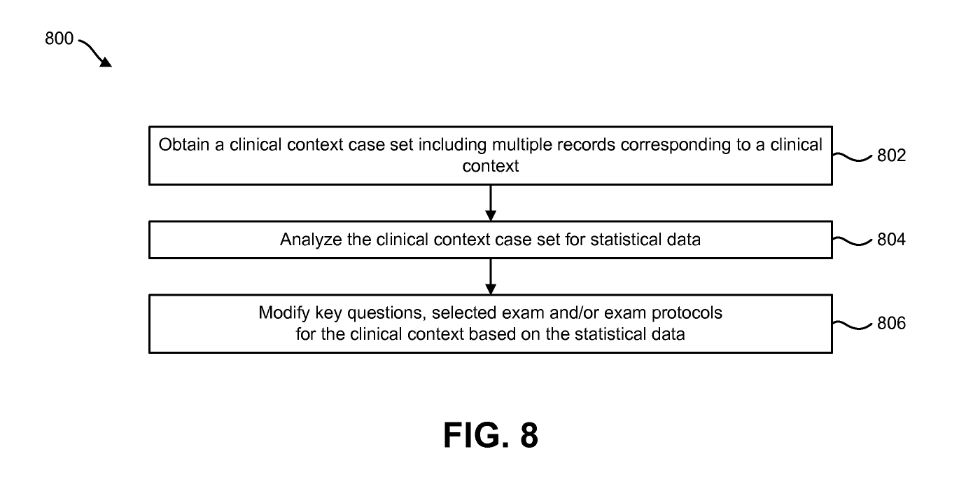

It should be noted however, that any number of key questions 116 may be associated with a clinical context 128. In some instances, the clinical context 128 may not have any key questions 116 associated with it. In this case, a set of default key questions 116 may be identified. Further, the key questions 116 associated with a clinical context 128 may be changed or modified. This is discussed in greater detail below in connection with FIG. 8. Additionally or alternatively, the number of key questions 116 may vary based on the clinical context 128 identified.

The lookup engine 112 may also determine for each key question what the codification of the question should be. These coded values may be stored directly in the database 104 or retained in memory for downstream processing.

The computing device 102 may obtain 210 an answer 118 to the key question 116. Each answer 118 may correspond to a key question 116 asked. A user, such as a medical professional examining a patient or interpreting test results, may input answers 118 into the computing device 102. For example, the user may provide answers 118 through a user interface (UI) 124 in an application 122, via an input device 120, by using voice dictation recognition software, etc. Accordingly, obtaining 210 an answer may include receiving an answer via an input device 120 and/or a user interface 124.

The computing device may codify 212 the answer 118 to produce a codified answer. For example, the computing device 102 may determine a code corresponding to the answer 118 (e.g., look up a code corresponding to the answer based on a mapping). A coding engine 110 within the codifying module 108 may codify 212 the answer 118 to a corresponding key question 116. In some configurations, the key question 116, the answer 118 and the corresponding clinical context 128 are each codified. In the example above, the clinical context 128 may be coded with the code 1234. Corresponding key questions 116 identified in connection with this clinical context 128 may be coded with the codes 1234.1q and 1234.2q, respectively. The respective answers 118 to the key questions 116 may be coded as 1234.1a and 1234.2q. By codifying the key questions 116 and answers 118, patient treatment and reporting can be streamlined due to increases in efficiency and better manageability of patient data. Further, coding key questions 116 and answers 118 in a hierarchical data model may prove valuable in an Enterprise Medical Record (EMR) system.

The computing device may store 214 the codified answer in a database 104. The database 104 may include stored codified answers along with their corresponding codified key questions 116. Further, the codified answers and key questions 116 may be linked to an associated codified clinical context 128. Codified elements may be used to spawn a wide variety of processes including decision support tools, utilization management and creation of new automated workflows. Additionally, stored codified data may be analyzed, studied, researched, compared, used for teaching and/or sold to vendors.

Further, a patient who has been identified with a specific clinical context 128 may benefit from codified information of past patients sharing the same or similar clinical contexts 128. Accordingly, the computing device 102 may provide 216 feedback (e.g., system support) based on one or more codified answers. In some configurations, the feedback is provided via a support system that is included in the application 122 or the clinical context module 106.

A specific example of how synoptic element structured reporting may provide 216 feedback will now be given. In particular, this example illustrates how answers 118 to key questions 116 for a given clinical context 128 may provide system support, which improves patient care through feedback. Suppose a number of patients check into an emergency room with attributes of cough, fever and shortness of breath in a period of a week. At first, the computing device identifies 202 a clinical context 128 of “perform a chest X-Ray to test for pneumonia” based on the inputted attributes.

The computing device 102 may also codify 204 the clinical context 128. Based on the clinical context 128, the clinical context module 106 in the computing device 102 may identify 206 key questions 116 by employing the key questions module 114, the lookup engine 112 and/or the database 104. For instance, one key question that is identified is, “Does the patient have focal opacities present in the lungs?” Other key questions may include, “Is there fluid around the lung?” The computing device 102 may also codify 208 the key questions 116.

To obtain 210 the answer 118 to this key question 116, the patient is given a chest X-Ray to test for the presence of pneumonia. If the results of the X-Ray are negative the key question 116 regarding focal opacities worrisome for pneumonia may be answered “no” or “negative.” In other words, the computing device 102 may obtain 210 the answer 118 to the key question 116. Although the X-ray image result may include additional information unrelated to the key questions 116, the primary focus of the exam is to answer a small number of these key questions 116. The answer 118 may also be codified 212. After codification, the codified context, question and answer may be stored 214 in the database 104.

This process may occur for a number of patients in the same location who have been given the clinical context 128 of “perform a chest X-Ray to test for pneumonia” based on their attributes (e.g., signs and symptoms, etc.). For each patient, the answer 118 to the key question 116 may be the same, e.g., negative for pneumonia.

Subsequently, when a patient arrives at the emergency room with similar attributes of cough, fever and shortness of breath, the support system may inform the medical provider that there is a demonstrated low yield (e.g., low probability) that the patient has pneumonia. For example, the support system may notify the medical provider, upon ordering a chest X-ray, that the clinical context 128 has had a demonstrated low yield of finding evidence worrisome for pneumonia. This medical provider may then use this feedback in treating the patient. Alternatively, the support system may provide statistical data to the medical provider ordering the chest X-ray of the likelihood of finding pneumonia based on information gathered from previous patients having similar clinical contexts 128. Accordingly, the support system can provide 216 feedback, such as updated information and recent statistics, to medical providers in a way that increases efficiency, frees up resources and benefits both medical providers and patients. Thus, valuable hospital resources can be better managed and utilized, which saves both time and money.

FIG. 3 is a flow diagram illustrating a method 300 for selecting a clinical context 128. One or more of the steps illustrated in FIG. 3 may be performed by one or more computing devices 102.

The computing device 102 may obtain 302 attributes based on patient presentment. Attributes may include age, gender, location, reason for exam, exam description, known diseases or issues, medical history and/or a variety of other characteristics. For example, a patient presents him or herself to a medical provider, such as at a hospital or clinic. The medical provider may identify various attributes from the patient. Further, one or more attributes may be inferred based on other submitted attributes. The user (e.g., medical provider) may input the attributes into the computing device 102. The computing device 102 may receive and/or store the attributes.

In some configurations, diagnostic questions may help identify a clinical context 128. For example, a set of default diagnostic questions could be asked to a patient to help identify attributes and narrow down a best suited clinical context 128.

The computing device 102 may determine 304 one or more clinical contexts 128 based on the attributes. A finite number of clinical contexts 128 can encompass a large majority of potential attribute combinations For instance, frequently occurring clinical contexts 128 include acute knee trauma, musculoskeletal acute injuries, acute chest pain, headaches, loss of vision, vomiting, abdominal pain and shortness of breath. Each of these clinical contexts 128, along with a finite number of additional clinical contexts 128, may encompass the majority of number of attribute combinations tied to a patient's injuries or disease processes.

Submitting additional attributes may help identify a more specific clinical context 128 that is better suited to a patient. For example, a 12-year-old female patient with acute chest pain may be associated with the clinical context 128 of “chest pain: rule out broken rib” while a 78-year-old male patient with acute chest pain may be associated with the clinical context 128 of “chest pain: rule out heart attack.”

In some configurations, the computing device 102 may select a number of clinical contexts 128 that are most probable from the attributes provided by the user (e.g., medical provider). For example, submitted attributes may be presented to the lookup engine 112 and potential clinical contexts 128 may be identified. In this example, a medical provider may input a symptom complex (e.g., a set of patient symptoms or attributes) into the computing device 102. Based on the symptom complex, the clinical context module 106 via the lookup engine 112 may identify one or more clinical contexts 128 with the highest positive yields. For instance, the clinical context module 106 may return feedback that the submitted symptom complex results in a higher percentage yield of the clinical context 128 “treat using antibiotics” than the clinical context 128 “chest X-Ray to rule out pneumonia.”

In one configuration, the computing device 102 may provide probability values or confidence values next to each clinical context 128 indicating how likely it is that each clinical context 128 matches given the attributes. The confidence values may change as additional attributes are obtained. For example, the computing device 102 may update the probability values or confidence values for each clinical context 128 based on the attributes. In this manner, the medical provider may select a clinical context 128 from a filtered list of possible clinical contexts 128 rather than from the full list.

In the case that no clinical context 128 can be identified, the computing device 102 may identify common patterns that might merit the creation of a new clinical context 128, along with associated key questions 116. In one example, the computing device 102 may receive a new clinical context 128 from user input, such as from a medical provider. In another example, the computing device 102 may produce a list of most likely clinical contexts 128 by combining together one or more of the presented attributes to arrive at a new clinical context 128. The newly created clinical context 128 may be subject to review and future modification and/or consolidation.

The computing device 102 may obtain 306 a selected clinical context 128 from the one or more clinical contexts 128. For example, the medical provider may select the clinical context 128 that best matches the patient's symptoms and presentments. The medical provider may provide the computing device 102 with the selection via an input device 120.

The computing device 102 may identify 308 key questions 116 based on the clinical context 128. This may be performed as described above in connection with FIG. 2. In some configurations, if no key questions 116 can be identified, key questions 116 from a related clinical context 128 may be used, new questions may be created or a default set of questions may be selected.

The computing device 102 may select 310 an exam based on the clinical context 128. For example, if the clinical context 128 is “chest X-ray to test for pneumonia,” then the exam may be a chest X-ray. As another example, if the clinical context 128 is “acute knee trauma,” then the exam may be a knee X-ray

As described above, the clinical context 128 may be codified. The code corresponding to the codified clinical context may be provided from one medical provider to a second medical provider via the computing device 102. For example, a referring doctor (e.g., first medical provider) may request that specific key questions 116 be answered by a radiologist (e.g., second medical provider) upon performing an X-ray. When requesting that the specific key questions 116 be answered, the referring doctor may send the code corresponding to the patient's clinical context 128 to the radiologist. The radiologist may then input the clinical context code into the computing device 102 to obtain the specific key questions 116 to be answered. In other words, the code associated with the clinical context 128 and/or the key questions 116 may be communicated to the second medical provider answering each question. This may provide the benefit of increased efficiency and simplicity in the medical environment by requiring only a simple code to be entered into the computing device 102. In one configuration, when the clinical context code is entered, the computing device may populate a template with the clinical context 128, key questions 116 and other relevant fields.

In some configurations, the computing device 102 may optionally populate 312 answers 118 based on previous codified answers. As described previously, answers 118 corresponding to key questions 116 may be stored in a database 104 and may provide feedback to a medical provider. One manner in which feedback may be provided is by querying answers 118 to previously asked key questions 116 associated with the same clinical context 128. Then, based on the previous answers, the computing device 102 may populate 312 the answers 118 that are most likely. In some configurations, the computing device 102 may require that the medical provider verify each answer, even if the answers 118 have been populated by default.

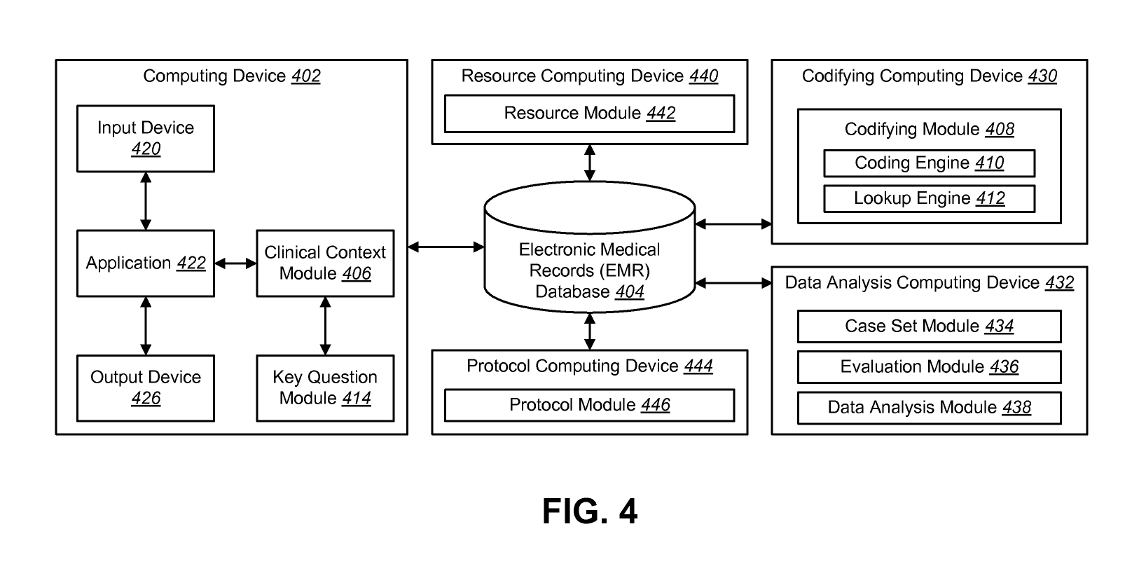

FIG. 4 is a block diagram illustrating an example of a computing network in which a computing device 402 for synoptic element structured reporting may be implemented. The computing device 402 illustrated in FIG. 4 may be configured similar to the computing device 102 illustrated in FIG. 1. The computing device 402 of FIG. 4 may include a clinical context module 406, a key question module 414, an input device 420, an application 422 and an output device 426 similar to corresponding components 106, 114, 120, 122, 126 described above in connection with FIG. 1.

FIG. 4 also illustrates a database 404 and other computing devices in communication with the computing device 402. These other computing devices may include a resource computing device 440, a codifying computing device 430, a protocol computing device 444 and a data analysis computing device 432. These other computing devices may be independent of, networked to and/or included within the computing device 402. In other words, each illustrated component may be located within the same physical structure or in separate housings or structures. Similarly, the database 404 may be a single database or multiple databases in communication with each other. For example, there may be a separate database for key questions 116, corresponding answers 118, patient information, uncodified results, patient images and/or other pieces of stored data. Alternatively, the data may all be stored in a central location (e.g., on a central computing device, server, network storage, etc.).

The resource computing device 440 may be in communication with the computing device 402 and the database 404. The resource computing device 440 may include a resource module 442. The resource module 442 may provide resources and references, such as reference links and collateral data pertaining to a clinical context 128 or a key question 116. For example, in the case of a urinary tract infection (UTI), a key question 116 regarding the grade of reflux may be asked. The answer choices may ask for a grade number in the range of one to five. Here, the resource module 442 may provide reference links to help identify and categorize the grade of reflux.

These resources may benefit medical providers in various stages of a patient's progression. For example, the resource module 442 may help in identifying a clinical context 128, interpreting exam results, providing the patient with information pertaining to their condition and/or communicating results to a patient. Further, the resource computing device 440 may gather information from the database 404, the Internet and/or other sources of stored data.

The codifying computing device 430 may include a codifying module 408 and may be configured similarly to the codifying module 108 described in FIG. 1. The codifying module 408 may include a coding engine 410 and a lookup engine 412. The codifying computing device 430 may be connected to the database 404 and the computing device 402. The coding engine 410 may create and assign codes to clinical contexts 128, key questions 116 and answers 118. The lookup engine 412 may look up coded data and/or may assist the coding engine 410 in identifying codes to be assigned to uncodified data.

The data analysis computing device 432 may be linked to the database 404 and the computing device 402. The data analysis computing device 432 may include a case set module 434, evaluation module 436 and data analysis module 438. The data analysis computing device 432 may perform a variety of functions, such as developing case sets and evaluating clinical contexts 128, key questions 116 and answers 118.

For example, the case set module 434 may identify and/or create case sets. A clinical context case set may be a combination of codified answers. Alternatively, a clinical context case set may be all the records including the same or similar clinical context 128. Case sets can provide numerous benefits to medical providers. For instance, a case set may be used for educational purposes, such as studying related cases, performing research and/or teaching students.

In some configurations, case sets may be used as a control, i.e., a control case set. In one instance, a control case set may assist a medical expert in interpreting results of a current patient and in answering a key question 116. For example, a doctor determining the reflux grade results of a urinary tract infection (UTI) image may compare a current patient's image to various case sets, each representing a different reflux grade.

Similarly, the control set may assist other medical providers in interpreting and clarifying exam results. For example, a medical provider may show a patient similar and/or contrasting results from one or more control case sets to better explain results to a patient. In another instance, a control case set may be used to test medical providers. For instance, similar to the UTI case above, a medical provider seeking training, licensing or certification may need to correctly identify the reflux grade of a UTI image belonging to a specific control case set.

The evaluation module 436 may evaluate clinical contexts 128. The evaluation module 436 may identify a clinical context 128 and determine whether the clinical context 128 needs redefining, division into multiple clinical contexts 128, subdivision into a hierarchy of clinical contexts 128 and/or other modifications. Additionally, the evaluation module 436 may evaluate key questions 116 and answers 118. The current adequacy and/or effectiveness of each key question 116 may be evaluated based on respective answers 118. Current key questions 116 may be replaced, deleted or modified and/or new key questions 116 may be added. Modification of each clinical context 128 and/or key question 116 may be done automatically by the computing device or by other means, such as a review by a panel of medical experts.

The data analysis module 438 may provide up-to-date statistical probabilities of a clinical context 128. For example, a user, such as an emergency room doctor, may use the data analysis module 438 to identify the likelihood of an answer 118 to a key question 116 given a clinical context 128. For instance, the data analysis module 438 may indicate that the patients with the clinical context 128 of “headache with a CT scan ordered” find abnormalities only 0.02% of the time when a computed tomography (CT) scan is ordered.

As another example, a medical expert interpreting an X-Ray result may use the data analysis module 438 to compare the likelihood of results. In this manner, medical providers can use the data analysis module 438 to better manage resources and more efficiently treat patients. The data analysis module 438 may return results from a specific time period or geographical area such as localized data, regional data from surrounding medical environments and/or national or international data.

The protocol computing device 444 may include a protocol module 446 and may be in communication with the computing device 402 and the database 404. The protocol module 446 may define best exam protocol practices to be employed by a medical provider, such as an imaging technician. An exam protocol may specify the exact type of examining/imaging needed to answer a specific question. In other words, the exam protocol may specify the discrete testing steps and machine parameters required to answer a key question 116.

Exam protocols may be based on past codified information for a clinical context 128. In this manner, the exam protocol may be modified over time to better treat patients, increase medical environment resource management and/or increase the accuracy of exam results. The protocol module 446 may also automatically populate the exam protocol parameters into a testing machine based on the clinical context 128.

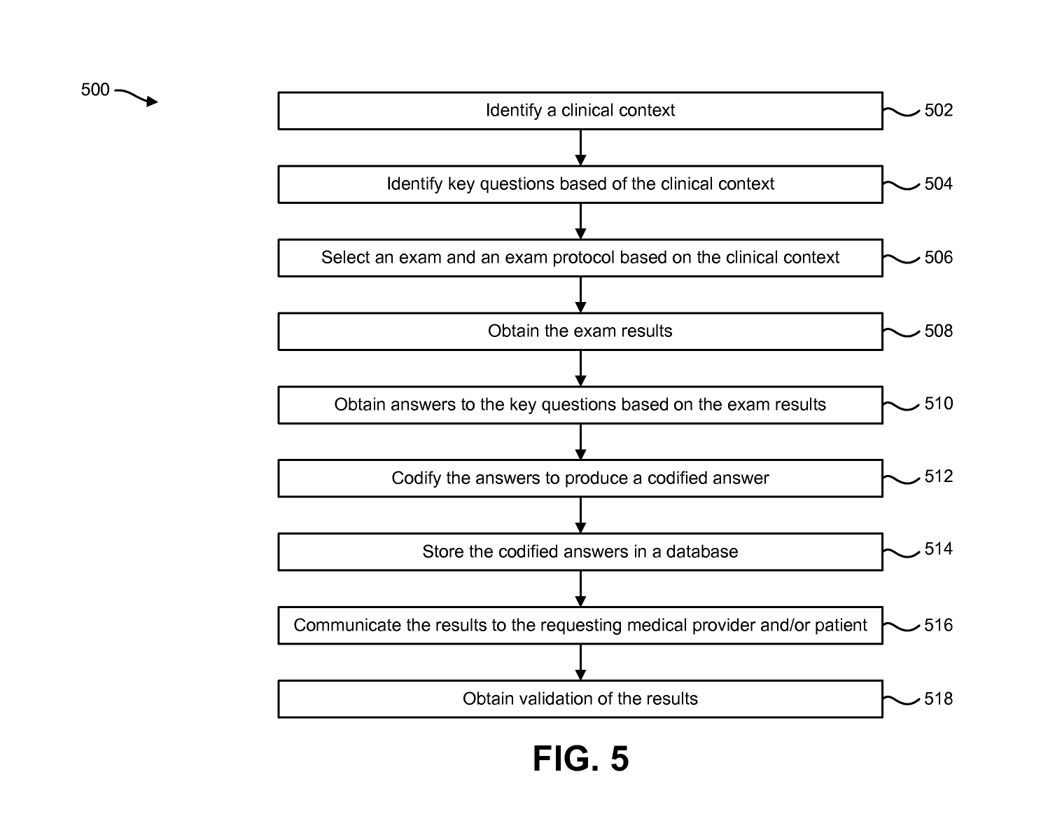

FIG. 5 is a flow diagram illustrating a more specific method 500 for synoptic element structured reporting. One or more of the steps of the method 500 illustrated in FIG. 5 may be performed by a computing device 102.

The computing device 102 may identify 502 a clinical context 128. For example, the computing device 102 may receive inputs from one or more users (such as a referring physician at the time of ordering an exam or a technologist at the time of exam). The computing device 102 may receive inputs in connection with computerized physician order-entry (CPOE), for instance. Additionally, a computer may match available attributes using best match methodologies to identify 502 a clinical context 128. Additional systems and methods may be employed for identifying 502 a clinical context 128, as described previously.

The computing device 102 may identify 504 key questions 116 based on the clinical context 128. This may be performed as described above.

The computing device 102 may select 506 an exam and an exam protocol based on the clinical context 128. As described above, the exam protocol may specify the discrete testing steps and machine parameters required to answer a key question 116. In other words, the exam protocol provides all the relevant information needed by a technician or technologist to conduct an exam. The exam protocol may include the number of chest X-Ray views needed, the angle of the X-Ray projection and other procedural elements. For example, in an MRI exam, the exam protocol may specify that an MRI operator take an axial T1 and T2 image and a sagittal T1 image.

Traditionally, a user, such as a technician, had to manually enter in information regarding each patient and exam, including each protocol. But as described above, a user may enter the clinical context code into the testing machine. The testing machine may communicate with the clinical context module 106 on the computing device 102 and may set the exam protocols for the patient's exam automatically. In some configurations, exam protocols for imaging devices that are defined by the clinical context may be automatically pre-loaded into the imaging device.

The computing device 102 may obtain 508 the exam results as well as exam interpretation. For example, the computing device 102 may obtain the results and interpretation from a user, such as a radiologist, who inputs the results into the computing device 102. In some configurations, the computing device 102 may automatically obtain exam results. For example, the computing device 102 may automatically obtain exam results performed by the computing device 102 or another computing device. For instance, the computing device 102 may analyze a blood sample and may automatically transfer over the results.

The computing device 102 may obtain 510 answers 118 to the key questions 116 based on the exam results. Based on the interpretation, answers 118 to the key questions 116 may be obtained 510 by the computing device 102 (by receiving answers 118 via an input device 120 and/or user interface 124, for example).

As described above, the answers 118 may be codified 512 to produce a codified answer. The answers 118 may be codified similarly to corresponding key questions 116. After codification of the answers 118, the codified answers may be stored 514 in a database.

In addition, when answers 118 to the key questions 116 for a clinical context 128 have been obtained 510, the computing device 102 may communicate 516 the results to a requesting medical provider (e.g., the medical provider that requested the key questions 116 be answered) and/or a patient. For example, a requesting doctor may receive the results from the examining doctor or may look them up using the computing device 102 before relaying the results to a patient. Alternatively, the results may be communicated directly to the patient via the computing device 102. The results may be communicated to the patient in a variety of other ways.

The computing device 102 may obtain 518 validation of the results. For example, the medical provider may ask the key question 116 of, “Is there a cancerous growth in the lungs?” If the answer 118 to the key question 116 came back positive, a biopsy may need to be performed to validate the result. The validation can then be provided to the computing device 102 for further reference. Other types of validation may also be performed. For example, a second opinion or a test result may constitute a validation.

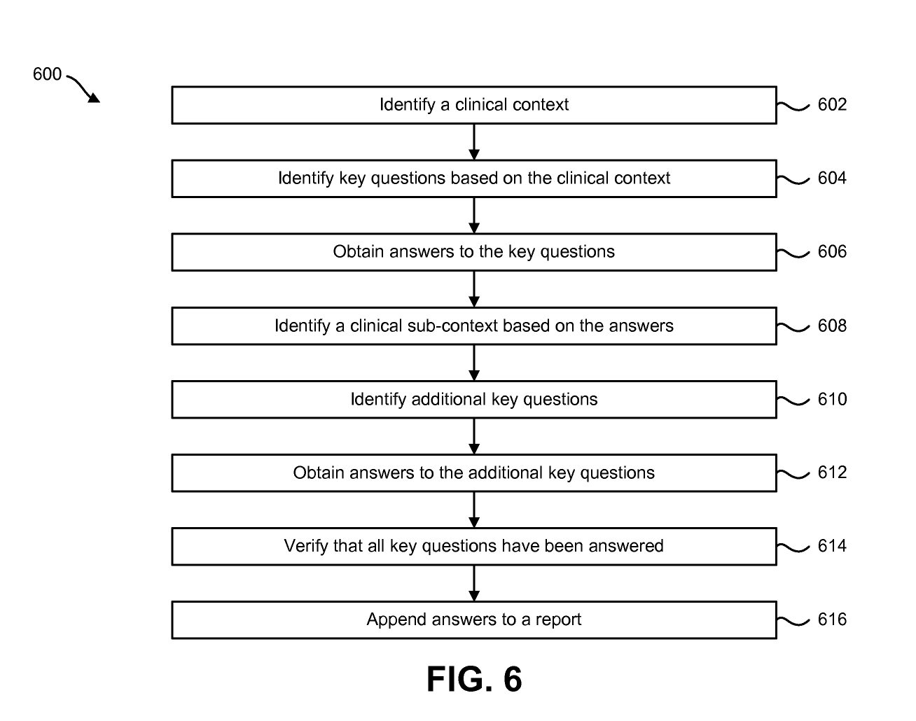

FIG. 6 is a flow diagram illustrating a method 600 for identifying key questions 116. One or more of the steps of the method 600 illustrated in FIG. 6 may be performed by a computing device 102.

The computing device 102 may identify 602 a clinical context 128. The computing device 102 may identify 604 key questions 116 based on the clinical context 128. The computing device 102 may obtain 606 answers 118 to key questions 116. The steps of identifying 602 a clinical context 128, identifying 604 key questions 116 and obtaining 606 answers 118 may be performed as described above.

In some configurations, the computing device 102 may identify 608 a clinical sub-context based on the answer 118 to the key question 116. For example, answers 118 may spawn additional synoptic elements and attributes. These additional attributes may then spawn a clinical sub-context. For example, a patient may arrive with a headache. The key question 116 may be, “Is this a general (e.g., uncomplicated) headache or a complex headache?” If the answer is that the headache is a complex headache, the clinical context 128 of “headache” may be refined to the clinical sub-context of “complicated headache.” In this manner, clinical contexts 128 may be organized in a hierarchal manner. As the clinical contexts 128 narrow, treatment of a patient may improve.

The computing device 102 may identify 610 additional key questions 116 (e.g., one or more additional key questions 116) based on the new clinical sub-context. For example, an additional identified key question 116 may be, “Does the patient have a brain tumor or brain hemorrhage?” Therefore, as more information is obtained, the clinical context 128 may be refined into clinical sub-contexts.

In some configurations, the computing device 102 may identify 610 additional key questions based on the answer 118 to the original key questions 116. For example, the clinical context 128 of “acute knee trauma” could identify an initial key question 116, such as “Is there a fracture, a dislocation or neither in the knee?” If the answer is a fracture, then secondary questions regarding the fracture's location and alignment could be presented. The computing device 102 may further obtain 612 answers to the additional key questions.

In some configurations, secondary questions may be coded based on the clinical context 128 and/or primary key question 116. For example, the clinical context 128 of “acute knee trauma” may be coded with the code 1234. A key question 116 identified in connection with this clinical context 128 (e.g., acute knee trauma) may be coded as 1234.1. Further, the two secondary questions spawning from the answer of the primary key question 116 may be coded 1234.1.1 and 1234.1.2, respectively.

In one configuration, the computing device 102 may verify 614 that all key questions have been answered. For example, a medical provider, such as a radiologist, may be prevented from submitting a report if one or more key questions 116 is unanswered. In this manner, every key question 116 is answered. This allows every answer 118 to be codified and stored for future analysis. This also ensures that a requesting doctor receives answers 118 to key questions 116 he or she submitted to be answered regarding the patient's condition.

In another configuration, the computing device 102 may append answers 118 to a report. For example, a medical provider, such as a radiologist, may answer key questions 116 while preparing his or her report. The answers 118 may be added to a new section within the report titled “Synopsis,” for example. The answers 118 may be placed in a structured template that includes the synoptic elements within the report and may be appended 616 before or after the report. Alternatively, the key questions 116 and answers 118 may replace the body of a report.

The report may be submitted to the computing device 102. Once answers 118 have been obtained by the computing device, the answers 118 may be codified and stored in a database 104. In some instances, the report may be stored in its entirety while only the key questions 116 and/or answers 118 are codified.

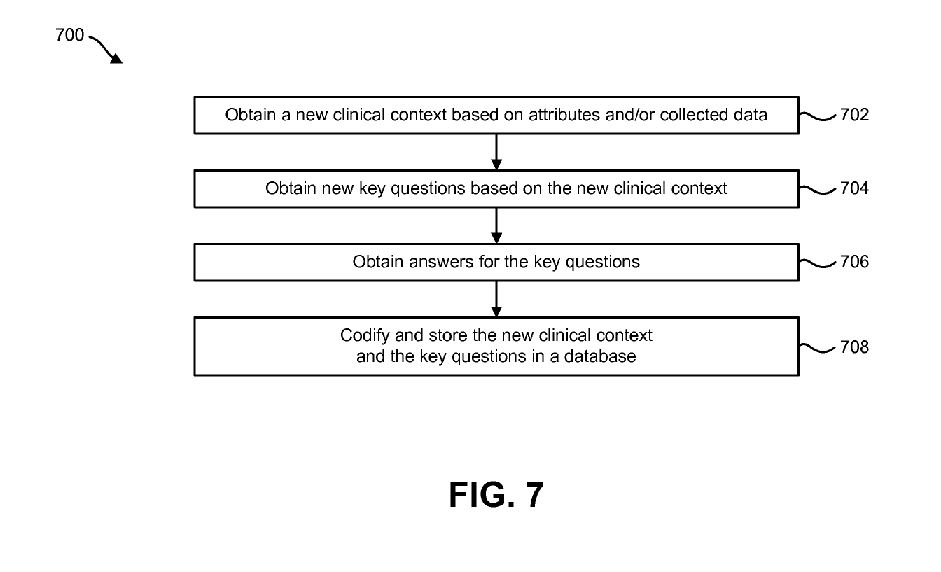

FIG. 7 is a flow diagram illustrating a method 700 of defining and codifying a clinical context 128. One or more of the steps of the method 700 illustrated in FIG. 7 may be performed by a computing device 102. Because the majority of clinical contexts 128 are based on repetitive attributes and synoptic elements, defining clinical contexts 128 may help provide greater efficiency to both patients and doctors (e.g., users or medical providers).

The computing device 102 may obtain 702 a new clinical context 128 based on one or more attributes and/or collected data. For example, a computing device 102 may receive input from one or more users (e.g., medical providers). For instance, the new clinical context 128 may be defined by a panel of medical experts, such as radiologists and referring clinicians, who identify a new clinical context 128, establish context attributes, and define associated synoptic elements. In another example, well-known and/or probabilistic data may determine a clinical context 128.

In yet another example, a clinical context 128 may be determined by the attributes that are included within the clinical context 128. This may occur when the clinical context 128 includes attributes that are rare, unusual and/or infrequent.

In some configurations, a new clinical context 128 may be determined, defined or obtained based on observed data. In this instance, the observed data may suggest that the original clinical context definition requires modification, divisions, subdivision or other changes. For example, data in an existing clinical context 128 may indicate two groups of patients. In this case, the two groups may be studied and a new clinical context 128 may be created to better treat patients in one of the groups.

Obtaining a clinical context 128 may include defining a codification schema for the new clinical context 128. For example, the attributes associated with the new clinical context 128 may be correlated with the new clinical context 128.

The computing device may obtain 704 new key questions 116 based on the new clinical context 128. Key questions 116 may be created and/or identified in a similar manner to defining a clinical context 128. For example, a computing device 102 may receive input from one or more users (e.g., medical experts or other medical providers such as doctors, nurses, technicians, technologists and/or other staff) in order to identify key questions 116 to be asked. Numerous key questions 116 may be identified, even if some key questions are not later used. Key questions 116 may also be scored based on importance and/or other factors to determine which questions are selected for the associated clinical context 128.

Default key questions 116 may also be identified to be used for clinical contexts 128 that do not include or are not yet associated with key questions 116. Further, secondary key questions may also be identified. Secondary key questions are questions that arise based on the answer to a primary or initial key question. For example, if the answer to a key question 116 indicates the presence of a tumor, secondary questions of size and location may be identified and presented.

Additionally, multiple clinical contexts 128 may share similar or overlapping key questions 116. After each key question 116 is identified, a codification schema for the key questions 116 may be defined.

The computing device 102 may obtain 706 answers 118 for the key questions 116 that are associated with each new clinical context 128. For example, if a group of medical experts identifies a key question 116 for a new clinical context 128, the same group may provide possible answers to that key question 116. Alternatively, the type of answer 118, such as if the answer 118 requires a measurement, a quantity, a range, a rank, a scale, a selection, etc., may be defined and provided to the computing device 102. Further, resources and information that may assist a user in answering each key question 116 may also be identified and provided to the computing device 102.

The computing device 102 may codify and store 708 the new clinical context 128 and the key questions 116 in a database 104. The clinical contexts 128 and key questions 116 for each newly obtained clinical context 128 may be stored in connection with each other or stored independently.

FIG. 8 is a flow diagram illustrating a method 800 for modifying a clinical context 128. One or more of the steps of the method 800 illustrated in FIG. 8 may be performed by a computing device 102.

The computing device 102 may obtain 802 a clinical context case set. A clinical context case set may include multiple records corresponding to a clinical context 128, as described above.

The computing device 102 may analyze 804 the clinical context case set for statistical data. For example, the clinical context 128 that defines the case set may be analyzed by comparing key questions 116 to answers 118 to determine the effectiveness of the key questions 116.

The computing device 102 may modify 806 key questions 116, selected exam and/or exam protocols for the clinical context based on the statistical data. In some configurations, the computing device 102 may update the clinical context 128 itself based on the statistical data. In this manner, the computing device 102 may automatically update the clinical context 128 and/or associated key questions 116 based on the feedback from the stored answers of the previous patients who exhibited the same clinical context 128. For instance, if a particular key question 116 provides a low yielding answer, that key questions 116 may be modified or replaced with another key question 116. Further, exam protocols may be modified to provide high yielding tests and eliminating low yielding tests.

By codifying clinical contexts 128 and answers 118, feedback and updated information may be provided to medical providers in a way that benefits both doctors and patients. For example, if a clinical context 128 is changed from “chest X-Ray to rule out pneumonia” to “treat chest pain using antibiotics” because of feedback received from answers 118, then scarce hospital resources such as personnel and equipment can be more efficiently scheduled and managed.

As another example, in the event that a first medical provider treats a first patient with a clinical context 128, and a second medical provider treats a second patient with the same clinical context 128, the synoptic element structured reporting system codifies and stores the data together. Further, the synoptic element structured reporting system codifies and stores the data together when a medical provider, for the same clinical context 128, orders tests for multiple patients administered by different radiologists. In some instances, medical centers in the same community or region may link databases together to better identify and treat clinical contexts 128. In this manner, data from a variety of sources is collected, codified and stored together, for future analysis and application. Accordingly, the result of synoptic element structured reporting due to codification of report data is improved productivity and improved standardization of report content.

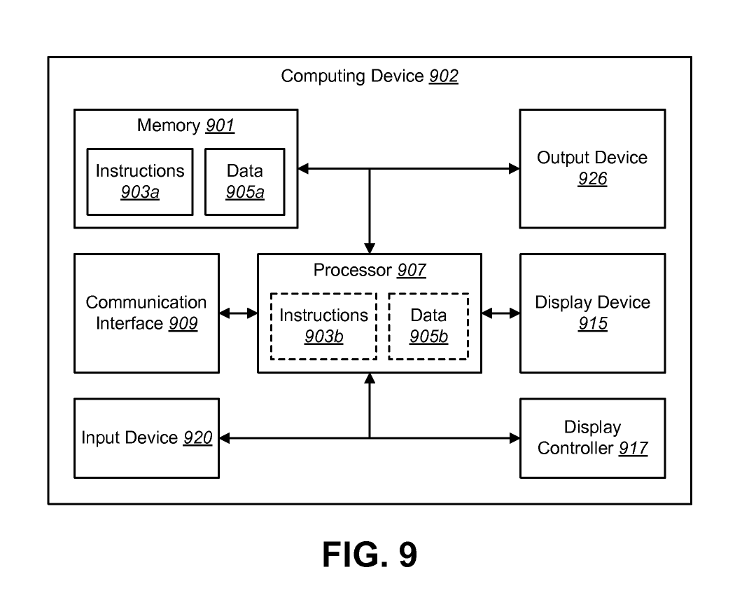

FIG. 9 illustrates various components of a computing device 902 that may be utilized for synoptic element structured reporting. The computing device 902 illustrated in FIG. 9 may be configured similar to the computing device 102 illustrated in FIG. 1 and/or to the computing device 402 illustrated in FIG. 4. The illustrated components may be located within the same physical structure or in separate housings or structures.

The computing device 902 may include a processor 907 and memory 901. The processor 907 controls the operation of the computing device 902 and may be implemented as a microprocessor, a microcontroller, a digital signal processor (DSP) or other device known in the art. The memory 901 may include instructions 903a and data 905a. The processor 907 typically performs logical and arithmetic operations based on program instructions 903b and data 905b stored within the memory 901. That is, instructions 903b and data 905b may be stored and/or run on the processor 907.

The computing device 902 typically may include one or more communication interfaces 909 for communicating with other electronic devices. The communication interfaces 909 may be based on wired communication technology, wireless communication technology, or both. Examples of different types of communication interfaces 909 include a serial port, a parallel port, a Universal Serial Bus (USB), an Ethernet adapter, an IEEE 1394 bus interface, a small computer system interface (SCSI) bus interface, an infrared (IR) communication port, a Bluetooth wireless communication adapter, and so forth.

The computing device 902 typically may include one or more input devices 920 and one or more output devices 926. As stated above, examples of different kinds of input devices 920 include a keyboard, mouse, microphone, remote control device, button, joystick, trackball, touchpad, lightpen, etc. Examples of different kinds of output devices 926 include a speaker, printer, etc.

One specific type of output device 926 that may be typically included in a computer system is a display device 915. Display devices 915 used with configurations disclosed herein may utilize any suitable image projection technology, such as liquid crystal display (LCD), light-emitting diode (LED), gas plasma, electroluminescence, a cathode ray tube (CRT), or the like. A display controller 917 may also be provided for converting data 905a stored in the memory 901 into text, graphics, and/or moving images (as appropriate) shown on the display device 915.

FIG. 9 illustrates only one possible configuration for synoptic element structured reporting on a computing device 902. Various other architectures and components may be utilized.

Many features of the configurations disclosed herein may be implemented as computer software, electronic hardware, or combinations of both. To clearly illustrate this interchangeability of hardware and software, various components will be described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present systems and methods.

Where the described functionality is implemented as computer software, such software may include any type of computer instruction or computer executable code located within a memory device and/or transmitted as electronic signals over a system bus or network. Software that implements the functionality associated with components described herein may include a single instruction, or many instructions, and may be distributed over several different code segments, among different programs, and across several memory devices.

The term “determining” (and grammatical variants thereof) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

Information and signals may be represented using any of a variety of different technologies and techniques. For example, data, instructions, commands, information, signals, bits, symbols and chips that may be referenced throughout the above description may be represented by voltages, currents, electromagnetic waves, magnetic fields or particles, optical fields or particles, or any combination thereof.

The various illustrative logical blocks and modules described in connection with the configurations disclosed herein may be implemented or performed with a general purpose processor, a digital signal processor (DSP), an application specific integrated circuit (ASIC), a field programmable gate array signal (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the configurations disclosed herein may be configured directly in hardware, in a software module executed by a processor, or in a combination of the two. A software module may reside in random-access memory (RAM) memory, flash memory, read-only memory (ROM) memory, erasable programmable ROM (EPROM) memory, electrically EPROM (EEPROM) memory, registers, hard disk, a removable disk, a compact disc ROM (CD-ROM) or any other form of storage medium known in the art (e.g., such as a non-transitory computer-readable). An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The methods disclosed herein include one or more steps or actions for achieving the described method. The method steps and/or actions may be interchanged with one another without departing from the scope of the present systems and methods. In other words, unless a specific order of steps or actions is required for proper operation of the configuration, the order and/or use of specific steps and/or actions may be modified without departing from the scope of the present systems and methods.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for synoptic element structured reporting on a computing device, comprising:
identifying a clinical context;
identifying a key question based on the identified clinical context;
obtaining an answer to the key question;
codifying the answer to produce a codified answer; and
storing the codified answer in a database.

2. The method of claim 1, wherein the clinical context, the key question and the answer are each codified.

3. The method of claim 1, wherein the clinical context is determined based on a patient attribute.

4. The method of claim 3, wherein the attribute is selected from the group consisting of age, gender, known diseases, reason for exam and patient location.

5. The method of claim 1, further comprising selecting an exam protocol based on the clinical context.

6. The method of claim 1, further comprising combining a plurality of codified answers to create a case set.

7. The method of claim 6, wherein the case set comprises statistical data regarding a clinical context.

8. The method of claim 7, further comprising modifying the key question based on the statistical data.

9. The method of claim 1, further comprising limiting a number of key questions to a predetermined number.

10. The method of claim 1, wherein each answer is selected from the group consisting of a measurement, a unit, a quantity, a range, a selection, a value, a rank, a scale and a text field.

11. The method of claim 1, wherein the clinical context is further divided into clinical sub-contexts.

12. The method of claim 1, further comprising identifying an additional key question based on the answer.

13. The method of claim 1, wherein the method is used for diagnostic imaging studies.

14. The method of claim 1, wherein the database comprises electronic medical records.

15. An apparatus for synoptic element structured reporting, the apparatus comprising:
a processor;
memory in electronic communication with the processor; and
instructions stored in the memory, the instructions being executable to:
identify a clinical context;
identify a key question based on the identified clinical context;
obtain an answer to the key question;
codify the answer to produce a codified answer; and
store the codified answer in a database.

16. The apparatus of claim 15, wherein the clinical context, the key question and the answer are each codified.

17. The apparatus of claim 15, further comprising instructions being executable to select an exam protocol based on the clinical context.

18. The apparatus of claim 15, wherein obtaining the answer identifies an additional key question.

19. A non-transitory computer-readable medium for synoptic element structured reporting, comprising executable instructions for:
identifying a clinical context;
identifying a key question based on the identified clinical context;
obtaining an answer to the key question;
codifying the answer to produce a codified answer; and
storing the codified answer in a database.

20. The computer-readable medium of claim 19, wherein the clinical context, the key question and the answer are each codified.
